(19) United States
(12) Patent Application Publication
(10) Pub. No.: US 2007/0163392 A1
(43) Pub. Date: Jul. 19, 2007

(54) Saw blade including teeth having a cutting portion with a wearing protection layer

(75) Inventors: Jorg H. Kullmann, Spangenberg (DE); Werner Kwanka, Vellmar (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: WIKUS-Sagenfabrik Wilhelm H. Kullmann GmbH & Co. KG

(21) Appl. No.: 11/649,944

(22) Filed: Jan. 5, 2007

(30) Foreign Application Priority Data
Jan. 13, 2006 (DE) 10 2006 001 816.8

(51) Int. Cl. B23D 57/00

(52) U.S. Cl. 76/112; 83/835

(57) ABSTRACT

A saw blade (15) includes a body (16) and a plurality of teeth (1). The teeth (1) include a cutting portion (2) of a geometrically defined shape and including a cutting edge (3). The cutting portion (2) includes a wearing protection layer (7) which covers the cutting edge (3). The cutting edge (3) has an edge radius (4) between approximately 0.005 mm and 0.045 mm relating to a condition of the cutting portion (2) without the wearing protection layer (7). Preferably, the wearing protection layer (7) is made of a hard material, especially TiN, TiCN, TiAlN, CrN or DLC.

### CROSS REFERENCE TO RELATED APPLICATIONS

This application claims priority to co-pending German Patent Application No. DE 10 2006 001 816.8 entitled “Sägeblatt mit einem Grundkörper und Zähnen mit einer Schneide mit einer Verschleiβschutzschicht”, filed Jan. 13, 2006.

### FIELD OF THE INVENTION

The present invention generally relates to a saw blade including a body and a plurality of teeth each including a cutting portion of a geometrically defined shape and including a cutting edge. A wearing protection layer covers the cutting edge of the cutting portion.

Especially, the saw blade is a saw band or a circular saw blade. Especially, at least the teeth are at least partly made of hard metal.

It is to be understood that the present specification and claims relate to a cutting portion of a geometrically defined shape. This is a technical term as defined in German standard DIN 8580 which defines cutting-off methods removing chips and using a cutting portion of a geometrically defined shape as turning on a lathe, drilling, milling, planing, broaching, sawing and filing. In contrast thereto, cutting-off methods removing chips using a cutting portion of a geometrically undefined shape are defined as grinding, honing and lapping, for example.

### BACKGROUND OF THE INVENTION

A saw band including a body and a plurality of teeth each including a cutting portion of a geometrically defined shape and including a cutting edge are known from the website of Tungsten Tool & Saw Co., Toronto/Canada at www.tungstentool.com/amada_aurora.html. A wearing protection layer covers the cutting edge of the cutting portion. The wearing protection layer is made of titanium nitrite (TiN). There is the problem with this known saw band that the wearing protection layer gets detached from the teeth during operation of the saw band already after a comparatively short period of time and that the properties reducing wear get lost.

A saw band including a body and a plurality of teeth each including a cutting portion of a geometrically defined shape and including a cutting edge are known from the website of American Saw & Mfg. Company, East Longmeadow, USA operating under the trademark “LENOX” at www.lenoxsaw.com/armor_blk.html. The cutting edge of the cutting portion is covered by a wearing protection layer. The wearing protection layer is made of aluminium titanium nitrite (AlTiN). There is the problem with this known saw band that the wearing protection layer gets detached from the teeth during operation of the saw band already after a comparatively short period of time and that the properties reducing wear get lost.

Another saw band including a body and a plurality of teeth each including a cutting portion of a geometrically defined shape and including a cutting edge is known from the website of American Saw & Mfg. Company, East Longmeadow, USA operating under the trademark “LENOX” at www.lenoxsaw.com/armor_gold.html. The cutting edge of the cutting portion is covered by a wearing protection layer. The wearing protection layer is made of titanium nitrite (TiN). There also is the problem with this known saw band that the wearing protection layer gets detached from the teeth during operation of the saw band already after a comparatively short period of time and that the properties reducing wear get lost.

A saw blade including a body and a plurality of teeth each including a cutting portion of a geometrically defined shape and including a cutting edge is known from German Patent No. DE 43 00 622 C2 corresponding to U.S. Pat. No. 5,477,763 and U.S. Pat. No. 5,425,296. The teeth may include carbide inserts which attain their final shape by a grinding operation, especially in the region of the cutting edge. Additional measures for reducing wear are not disclosed.

Saw bands including a body including a galvanic coating of diamond particles in the region of the continuous or broken edge are known from the leaflet “Precision Band Saw Blades”, edition 2005, pages 44-46 of WIKUS-Sägenfabrik Wilhelm H. Kullmann GmbH & Co. KG. Thus, this is a saw band including a multitude of cutting portions of geometrically undefined shape being formed by the diamond particles. There are no teeth in the sense of elements protruding from the body at a chip angle. Such saw bands including cutting portions of geometrically undefined shape rather operate in a grinding way. The thickness of the galvanic coating is approximately between 0.3 mm to 0.4 mm. The diamond particles are fixedly located in a nickel layer. However, bonding of the galvanic layer on the material of the body is insufficient such that there are cracking effects in the region of the cutting portions when using such saw bands.

Furthermore, tools removing chips and having a cutting portion of geometrically defined shape, namely drills, are known from the website of Plasma+Rubber-coatings AG, Schaan Liechtenstein at www.rhenotherm.de/Dlcdlc.html. A wearing protection layer is located in the region of the body. The wearing protection layer is a DLC layer (DLC=diamond-like carbon) which is hard and brittle. The DLC layer has a small coefficient of friction such that when using it the chip flow is only disturbed to a comparatively small extent and such that there only is a moderate increase of temperature. The DLC layer is deposited by a CVD process (CVD=chemical vapour deposition).

As it is generally known in the prior art, the above described CVD process is mostly conducted at reduced pressure and at high temperatures. It finds its limits in the temperature stability of the material of the body such that the use of the CVD process is limited to tools removing chips such as drills for which the geometric dimensions of a cutting portion have a certain relation with respect to the chip thickness. Typically, such drills have cutting edges with an edge radius of between 0.060 mm and 0.200 mm. The associated chip thicknesses are in a range of approximately 0.200 mm to 0.800 mm. These conditions substantially differ from the geometric conditions as they prevail when sawing with saw blades.

Furthermore, saw blades including a body and a plurality of teeth each including a cutting portion of geometrically defined shape and including a cutting portion are generally known in the prior art. The cutting portion is made of hard metal, and it is finished by grinding the tooth face and the tooth back. The average “edge radius” is between 0.005 mm and 0.010 mm in the ground state of the tooth face and the tooth back. However, this “edge radius” rather is an accidental ragged design of the cutting portion. The cutting edge itself is not machined. When considering the size and the accidental irregular shape, it is rather not appropriate to designate this shape as an edge radius. The corresponding chip thickness is in a range of approximately 0.003 mm to 0.020 mm. There are no special measures for reducing wear.

### SUMMARY OF THE INVENTION

The present invention relates to a saw blade including a body and a plurality of teeth. The teeth include a cutting portion of a geometrically defined shape. The cutting portion includes a cutting edge. The cutting portion includes a wearing protection layer. The wearing protection layer is designed and arranged to cover the cutting edge. The cutting edge has an edge radius between approximately 0.005 mm and 0.045 mm relating to a condition of the cutting portion without the wearing protection layer.

The present invention also relates to a method of producing a saw blade including a body and a plurality of teeth. The method includes the steps of grinding a tooth for producing a cutting portion of a geometrically defined shape and including a cutting edge; finishing the cutting portion in a way that the cutting edge has an edge radius between approximately 0.005 mm and 0.045 mm; and applying a wearing protection layer on the cutting portion in a way that the wearing protection layer covers the cutting edge.

The novel saw blade includes teeth having a cutting portion which is designed such that protection against wear lasts longer and is improved compared to the prior art.

The present invention is based on the surprising perception that for improving the wear properties of a saw blade, this saw blade initially needs to be subjected to certain “wear” in a conscious and defined way. Afterwards, the wearing protection layer can be deposited on the saw blade, and it adheres substantially better and longer on the cutting portion than it is the case when depositing it on a non-machined, irregular and sharp cutting edge as it is known in the prior art. More particularly, the defined wear is realized by applying an edge radius at the cutting edge of the cutting portion of the saw blade which is between approximately 0.005 mm and 0.045 mm. These values relate to a condition of the saw blade without the wearing protection layer. It is to be understood that after depositing the wearing protection layer, the wearing protection layer with its outer surface forms the effective cutting portion and the cutting edge. Consequently, depending on the thickness of the wearing protection layer there is a different (meaning greater) effective edge radius when measuring it after the deposition of the wearing protection layer.

First of all, it needs to be considered that when sawing material—compared to other cutting-off methods removing chips and including a cutting portion of geometrically defined shape, for example drilling or milling—it is desired to remove comparatively thin chips. The cutting forces to be applied during sawing are mostly proportional to the chip thickness. In other words, thicker chips require higher cutting forces than thinner chips. It is a perception of the inventors that positive process results are realized when producing an effective chip thickness during sawing which is in a range of approximately 0.015 mm to 0.030 mm. The effective chip thickness is the actual feed per tooth. The effective chip thickness is to be differentiated from the theoretical feed per tooth. The actual feed per tooth results from the distribution of the cutting channel in cutting segments which are associated with certain teeth. Until now, it was the perception of a person with skill in the art that such thin chips can only be produced with saw blades having very sharp cutting edges. This means that the “edge radius” of the cutting portion at each tooth should be designed to be very small. In case the cutting edges made of hard metal are produced by grinding the tooth face and the tooth back, such a saw blade having comparatively sharp teeth may be produced without substantial problems. The teeth have a very small edge radius which is approximately in a range of 0.005 mm. However, this rather is an accidental ragged design of the cutting portion. The cutting edge itself is not machined. It is rather inappropriate to designate such a design as having an edge radius when considering its size and its accidental irregular shape.

The present invention is also based on the perception that it makes sense to improve the properties of saw blades by depositing at least one wearing protection layer on the cutting portions of the teeth at least in the region of the cutting edge. The wearing protection layer or wearing protection coating may cover the entire cutting portion, the entire tooth, a part of the body or even the entire saw blade, for example. However, a design is preferred in which the wearing protection layer covers the entire cutting portion and a part of the body. In contrast to the prior art, it is desired that the novel wearing protection layer sufficiently adheres to the material of the body and of the teeth, respectively, as it corresponds to the predetermined lifetime of the saw blades. The wearing protection layer is chosen such that it provides improved properties during sawing. For example, it is desired that such a wearing protection layer has an increased hardness and consequently an improved resistance against abrasion to be capable of achieving a longer service life of the novel saw blade. It is also advantageous if the coefficient of friction of such a wearing protection layer is comparatively small to achieve the results of a good flow of the chips during sawing and low heating effects of the saw blade itself.

Bonding of such wearing protection layers in the region of sharp cutting edges of the cutting portion of a tooth of saw blades of the prior art shows problems, as it has been perceived by the present invention. This especially applies when using small edge radiuses, for example such ones in a range of between 0.005 mm and 0.010 mm. In this case, the applied wearing protection layers of the prior art are under tension which may lead to the wearing protection layers not permanently adhering, but in the worst case getting detached from the surface very quickly due to release of the internal stress. Forces acting during sawing may also cause or at least promote such a detachment process of wearing protection layers in the prior art such that there are no sufficient usable times of such known saw blades.

The present invention consciously gives up the goal of attaining cutting edges having a design as sharp as possible. With the present invention, the geometrical conditions in the region of the cutting edge are limited to value ranges which make it possible to attain an optimum between the contrary demands of a sharp saw blade, on the one hand, and sufficient bonding of the wearing protection layer, on the other hand. This optimum is coordinated with a chip thickness in a range between 0.015 mm and 0.030 mm. An edge radius is chosen which is slightly greater than the edge radius which could be produced by grinding. The edge radius being increased insofar leads to the saw blade being less sharp. The edge radius is determined in a range between 0.004 mm and 0.05 mm. Especially good working results are achieved when the edge radius is between 0.010 mm and 0.025 mm. It is to be understood that the edge radius as seen under a microscope is no exact radius since such an exact radius cannot be produced in reality. However, the average radius is in the above mentioned value range. The term radius as used in this application is also to be understood as relating to a different bent design which also leads towards the goal of leaving the sharp shape of the non-machined cutting edge. In this way, one attains sufficient bonding properties of the wearing protection layer and a respective service life of the saw blade. At the same time, compared to saw blades of the prior art, the cutting force at a certain comparison point in time after a certain action time of the novel saw blade and of a saw blade of the prior art is reduced by the novel saw blade since the above explained portions of the edge radiuses of the novel saw blade are then still smaller than the ones of the saw blades of the prior art (which are already worn-out to a greater extent at this comparative point in time).

The cutting portion of the saw blade preferably is made of hard metal, meaning especially steel being alloyed with tungsten and/or cobalt. Tungsten is the actual hard material and cobalt—as well as other possible alloys—is the binder. However, it is also possible to use super-speed steel, for example. The wearing protection layer may be made of hard material. Especially, hard material is to be understood as including TiN, TiCN, TiAlN, CrN and DLC. The wearing protection layer may be designed to include one or more layers. When using a single layer design, the wearing protection layer is especially made of TiN, TiCN, TiAlN or CrN. It is also possible that a plurality of different layers—for example two, three or even four layers—form the wearing protection layer. When using such a multi-layer design, the at least one intermediate layer is especially made of TiN, TiCN, TiAlN or CrN and the surface layer being located on the intermediate layer is especially made of DLC. Preferably, the wearing protection layer is deposited by a PVD process (PVD=physical vapor deposition). When using a multi-layer design, this applies to the surface layer as well as to the at least one intermediate layer.

Usually, the cutting portions of the teeth of the novel saw blade will be produced by grinding. Grinding is followed by a finishing process which desires to reduce the ragged design of the cutting edge and to increase the edge radius, respectively, and to round the cutting edge before applying the wearing protection layer. This finishing process desiring to reduce the ragged design and to round the cutting edge may be especially realized by brushing, abrasive-blasting or trimming, meaning by measures which apply a rounding effect and a leveling effect to the cutting edge. However, the finishing process is to be chosen such that one does not attain dull saw blades, meaning no saw blades as they prevail due to wear at the end of their service life. It is also desired to prevent properties of saw blades with which the chips to be removed are comparatively thick, meaning in a range of approximately 0.060 mm.

The material of the body of the saw blade is preferably made of hard metal. The saw blade especially is a saw band or a circular saw blade. The body of a saw band is the back of the band from which the teeth protrude. In this case, the teeth are also made of hard metal, they are initially produced by milling and they are later finished by grinding. However, the teeth may also only include inserts made of hard metal. In this case, the teeth (not including the inserts) and the body are made of a softer material, for example steel. Furthermore, the inserts of hard metal may include PKD (PKD=polycrystalline diamond). In the following, the teeth are finished. In this way, the geometrical shape of the cutting portion is determined before depositing the wearing protection layer.

It is especially preferred to deposit a multi-layer, especially a two-layer wearing protection layer on the material of the body and of the teeth in the region of the cutting portions of the teeth, respectively. Preferably, at first an intermediate layer made of a material selected from the group consisting of TiN, TiCN, TiAlN and CrN is applied. The thickness of the intermediate layer preferably is in a range of approximately between 0.002 mm to 0.004 mm. The intermediate layer has the goal of improving bonding of a surface layer and also to act as a barrier layer between the surface layer and the material of the body and of the tooth, respectively. This especially applies when the preferred DLC layer is used as the surface layer. The surface layer also preferably has a thickness of approximately between 0.002 mm to 0.004 mm. In this way, the finished (complete) tooth has a layer thickness of the complete (two-layer) wearing protection layer of between approximately 0.004 mm to 0.008 mm and effective cutting edge radiuses in a range of approximately between 0.016 mm to 0.031 mm, meaning exactly such ones in the region of the predetermined chip thickness.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a general plan view of a section of a first exemplary embodiment of the novel saw blade being designed as a saw band.

FIG. 2 is a general plan view of a section of a second exemplary embodiment of the novel saw blade being designed as a saw band including carbide inserts.

FIG. 3 is a view of a third exemplary embodiment of the novel saw blade being designed as a circular saw blade.

FIG. 4 is a strongly enlarged view of the tip of a tooth of the novel saw blade during sawing.

FIG. 5 is a further enlarged view of the tip of a partly worn-out tooth during sawing.

FIG. 6 is a diagram illustrating the cutting force and the bonding properties of a wearing protection layer on the Y-axis and the edge radius on the X-axis.

FIG. 7 shows a microscopic recording of the tip of a tooth of the novel saw blade, the tooth including a wearing protection coating.

### DETAILED DESCRIPTION

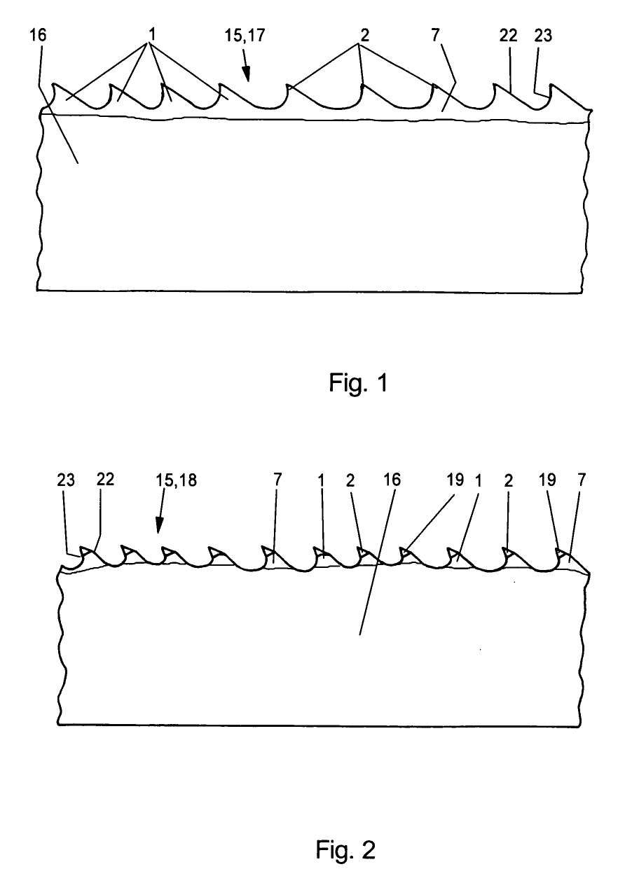

Referring now in greater detail to the drawings, FIG. 1 illustrates a general plan view of a part of a first exemplary embodiment of a novel saw blade 15 being designed as a saw band 17. The saw blade 15 includes a body 16 and a plurality of teeth 1. FIG. 1 only illustrates a part of the saw blade 15 such that only a part of its body 16 and only a part of its teeth 1 are visible. It is to be understood that the body 16 includes further teeth 1 along its extension.

FIG. 2 is a general plan view illustrating a part of a second exemplary embodiment of the novel saw band 15 being designed as a saw band 18 including carbide inserts 19. The carbide inserts 19 may however also have a different shape.

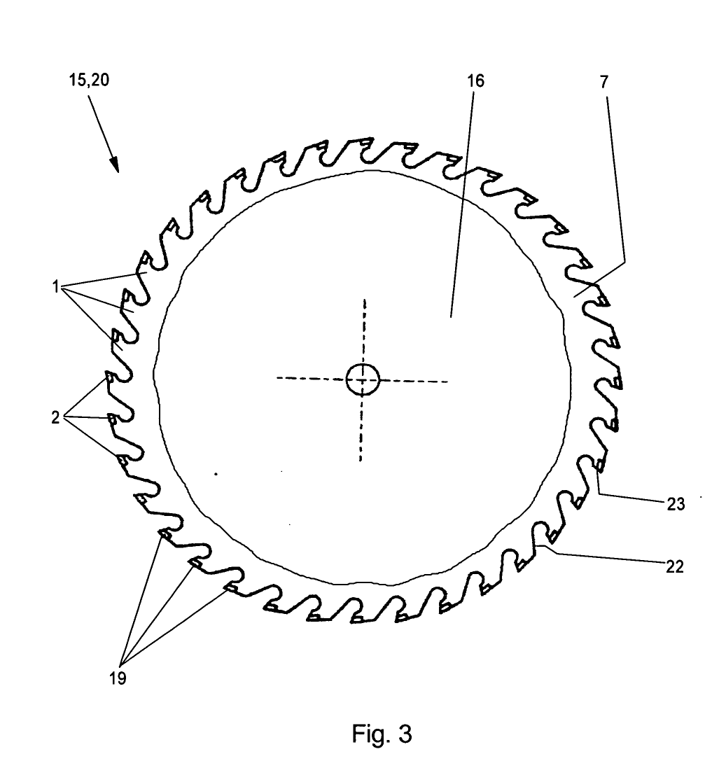

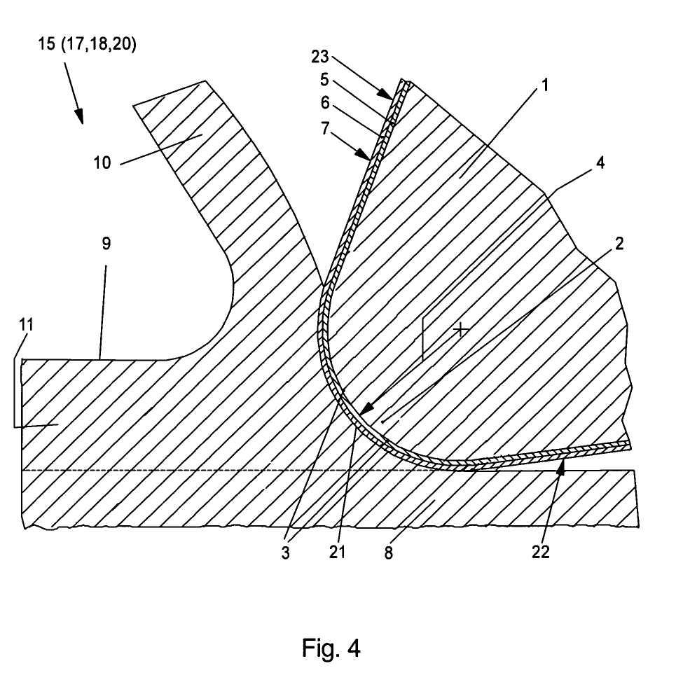

FIG. 3 illustrates a third exemplary embodiment of the novel saw blade 15 being designed as a circular saw blade 20. The circular saw blade 20 may however also include carbide inserts.

FIG. 4 is an enlarged illustration of the tip of a tooth 1 during sawing. The exemplary tooth 1 is a tooth of one of the embodiments of the saw blades 15 being illustrated in FIGS. 1-3. The tooth 1 includes a cutting portion 2. The tooth 1 is at least partly made of hard metal extending over the entire region of its cutting portion 2. The cutting portion 2 ends in a cutting edge 3 having an associated edge radius 4. The edge radius 4 is approximately between 0.005 mm and 0.045 mm, especially approximately between 0.010 mm and 0.025 mm. The edge radius 4 has been produced by grinding, and it is limited to the defined region by finishing. The tooth back 22 and the tooth face 23 are located next to the cutting edge 3.

In this way, the cutting portion 2 having a geometrically defined cutting shape is formed in a preliminary way. The preliminary cutting portion 2 is covered by an intermediate layer 5 and a surface layer 6 being located thereon, the two layers 5 and 6 forming a wearing protection layer 7. In the described case, the wearing protection layer 7 includes two layers. However, it is to be understood that the wearing protection layer 7 may also be made of one single layer or of more than two layers. In the present case, the intermediate layer 5 includes titanium nitrite (TiN), and the surface layer 6 includes DLC (diamond-like carbon). The layers 5, 6 are deposited one after the other by a PVD process (physical vapor deposition process). In this way, the outer surface of the wearing protection layer 7 forms the effective cutting edge during actual cutting and sawing, respectively.

Such a novel saw blade 15 with its multitude of such teeth 1 penetrates into the material of a work piece 8 from the side of its surface 9, and it removes a chip 10 and a series of chips 10, respectively, during sawing. In this way, a chip thickness 11 is attained. It is desired to attain a chip thickness 11 having a size in the range between approximately 0.015 mm and 0.030 mm depending on the above described size of the cutting portion 2 and of the cutting edge 3, respectively. It is to be seen that the edge radius 4 has a value in a range which approximately corresponds to the range of the chip thickness 11. The range may be identical or slightly less than the range of the chip thickness 11. In this way, one attains a saw blade 15 having sufficiently sharp teeth 1 removing comparatively thin chips 11 from the work piece 8 while the required cutting force is kept low in an advantageous way and the properties of the surface layer 6 result in easy chip flow and low heating of the teeth 1. However, the wearing protection layer 7 securely adheres to the teeth 1.

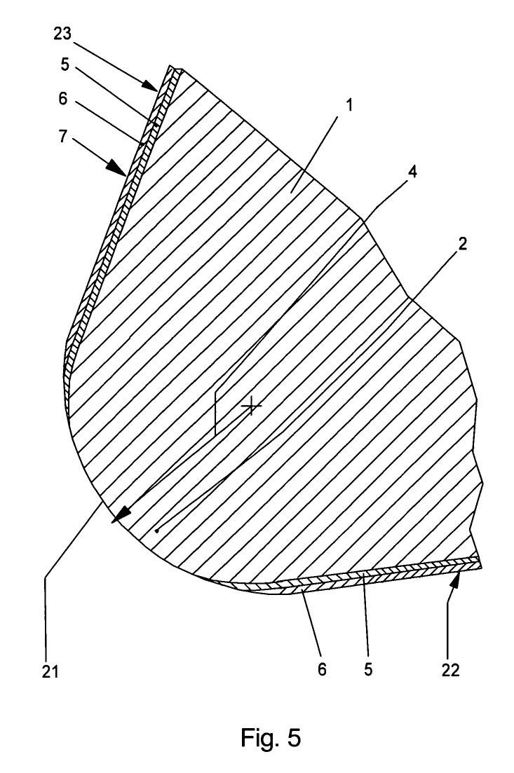

FIG. 5 illustrates an even more enlarged view of the tip of the tooth 1 according to FIG. 1 during sawing. However, FIG. 5 illustrates a condition in which the saw blade 15 already has gone through a certain action time. Correspondingly, it is to be seen that the wearing protection layer 7 has already been partly removed. The cutting portion 2 also does not have its initial shape. However, FIG. 5 also illustrates that parts of the wearing protection layer 7 are still there and that they still contact the chips. Consequently, the wearing protection layer 7 still fulfills a part of its wearing reducing effect such that even in this condition it still increases the working life of the saw blade 15.

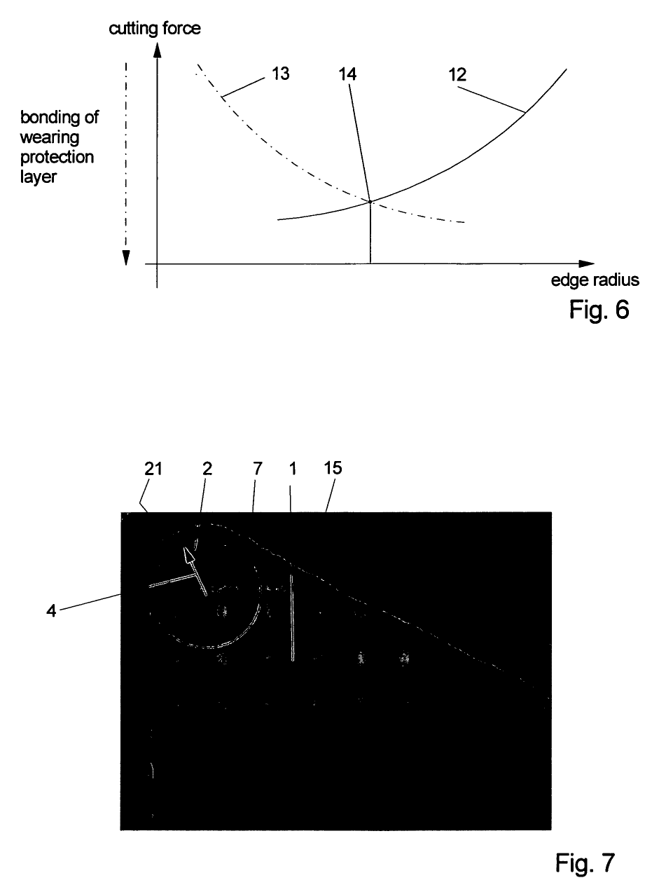

FIG. 6 is a diagram schematically emphasizing the optimal coordination of the geometric shape of the teeth 1 in the region of the cutting portion 2 and of the cutting edge 3, respectively, with respect to the bonding properties of the wearing protection layer 7. The diagram only serves to emphasize the tendency. The abscissa (X-Axis) shows the edge radius 4. The ordinate (Y-Axis) shows the cutting force, on the one hand, and the bonding properties of the wearing protection layer 7, on the other hand.

As a result, there is an ascending continuous curve 12 illustrating the cutting force being required for cutting a work piece 8. The cutting force increases when the edge radius 4 is increased. This relation has been experienced before in the sense of a worn-out, dull saw blade 15 requiring a greater cutting force than a new, sharp saw blade 15. In other words, the cutting force is advantageously small when designing the cutting edge 3 to be very sharp. The dot-dash line 13 however shows that the bonding properties of the wearing protection layer 7 are reduced when the edge radius 4 is reduced. This tends to lead to the effect of the wearing protection layer 7 not being capable of fulfilling its function in the desired way. The point of intersection 14 results from these two opposite tendencies and from the respective course of the respective course of the curves 12, 13, respectively. Optimal conditions prevail in the point of intersection 14. According to the present invention, the point of intersection 14 is located at an edge radius 4 of between approximately 0.005 mm and 0.045 mm, especially between approximately 0.010 mm and 0.025 mm.

Finally, FIG. 7 shows a microscopic recording of a tip of a tooth 1 of the novel saw blade 15, the tooth 1 including a wearing protection layer 7. The edge radius 4 is approximately 0.016 mm. It is to be seen that the edge radius 4 as seen microscopically is no exact radius since such an exact radius cannot be produced in reality. However, the average edge radius 4 has the above mentioned value.

Many variations and modifications may be made to the preferred embodiments of the invention without departing substantially from the spirit and principles of the invention. All such modifications and variations are intended to be included herein within the scope of the present invention, as defined by the following claims.

We claim:

1. A saw blade, comprising,
a body; and
a plurality of teeth,
said teeth including a cutting portion of a geometrically defined shape,
said cutting portion including a cutting edge,
said cutting portion including a wearing protection layer, said wearing protection layer being designed and arranged to cover said cutting edge,
said cutting edge having an edge radius between approximately 0.005 mm and 0.045 mm relating to a condition of said cutting portion without said wearing protection layer.

2. The saw blade of claim 1, wherein said edge radius is approximately between 0.010 mm and 0.025 mm.

3. The saw blade of claim 1, wherein said body and said teeth are made of hard metal and said wearing protection layer includes hard material.

4. The saw blade of claim 2, wherein said body and said teeth are made of hard metal and said wearing protection layer includes hard material.

5. The saw blade of claim 1, wherein said teeth include carbide inserts and said wearing protection layer is made of hard material.

6. The saw blade of claim 2, wherein said teeth include carbide inserts and said wearing protection layer is made of hard material.

7. The saw blade of claim 1, wherein said wearing protection layer has a thickness of approximately between 0.002 mm and 0.008 mm.

8. The saw blade of claim 2, wherein said wearing protection layer has a thickness of approximately between 0.002 mm and 0.008 mm.

9. The saw blade of claim 3, wherein said wearing protection layer has a thickness of approximately between 0.002 mm and 0.008 mm.

10. The saw blade of claim 4, wherein said wearing protection layer has a thickness of approximately between 0.002 mm and 0.008 mm.

11. The saw blade of claim 1, wherein said wearing protection layer includes an intermediate layer and a surface layer, said intermediate layer being designed and arranged for providing a fix connection with said cutting portion, said surface layer being designed and arranged for providing hardness and wearing resistance.

12. The saw blade of claim 2, wherein said wearing protection layer includes an intermediate layer and a surface layer, said intermediate layer being designed and arranged for providing a fix connection with said cutting portion, said surface layer being designed and arranged for providing hardness and wearing resistance.

13. The saw blade of claim 11, wherein said intermediate layer includes a material selected from the group consisting of TiN, TiCN, TiAlN and CrN and said surface layer includes DLC.

14. The saw blade of claim 12, wherein said intermediate layer includes a material selected from the group consisting of TiN, TiCN, TiAlN and CrN and said surface layer includes DLC.

15. The saw blade of claim 13, wherein said intermediate layer has a thickness of approximately between 0.002 mm and 0.004 mm.

16. The saw blade of claim 13, wherein said surface layer has a thickness of approximately between 0.002 mm and 0.004 mm.

17. The saw blade of claim 13, wherein said intermediate layer has a thickness of approximately between 0.002 mm and 0.004 mm and said surface layer has a thickness of approximately between 0.002 mm and 0.004 mm.

18. The saw blade of claim 1, wherein said edge radius is determined in response to a point of intersection of a course of the bonding properties of said wearing protection layer on said cutting portion and a course of the cutting force.

19. The saw blade of claim 2, wherein said edge radius is determined in response to a point of intersection of a course of the bonding properties of said wearing protection layer on said cutting portion and a course of the cutting force.

20. A method of producing a saw blade including a body and a plurality of teeth, said method comprising the steps of:
grinding a tooth for producing a cutting portion of a geometrically defined shape and including a cutting edge;
finishing said cutting portion in a way that said cutting edge has an edge radius between approximately 0.005 mm and 0.045 mm; and
applying a wearing protection layer on said cutting portion in a way that said wearing protection layer covers said cutting edge.

21. The method of claim 20, wherein said edge radius is approximately between 0.010 mm and 0.025 mm.

22. The method of claim 20, wherein said step of finishing is realized by a method selected from the group consisting of brushing, abrasive-blasting and trimming.

23. The method of claim 21, wherein said step of finishing is realized by a method selected from the group consisting of brushing, abrasive-blasting and trimming.
